(19) United States
(12) Patent Application Publication
(10) Pub. No.: US 2024/0027299 A1
(43) Pub. Date: Jan. 25, 2024

(54) Leak Testing Apparatus and Method

(71) Applicant: Vestel Elektronik Sanayi Ve Ticaret A.S., Manisa (TR)

(72) Inventor: Görkem Özvural, Manisa (TR)

(21) Appl. No.: 18/257,683

(22) PCT Filed: Dec. 17, 2020
(86) PCT No.: PCT/EP2020/086763

§ 371 Date: Jun. 15, 2023

(51) Int. Cl. G01M 3/26

(52) U.S. Cl. CPC G01M 3/26

(57) ABSTRACT

The disclosure provides a leak testing apparatus and method of testing a device for leaks. The device may be an industrial product, such as an electrical housing with one or more sealable orifices. The leak testing apparatus includes a pump, a pressure chamber, a pressure sensing unit, a control, processing and decision unit, and a user interface. A first valve can connect the pump to the pressure chamber, and a second valve can connect the pressure chamber to the device under test. The pump is connected to a gas source or sink. The pump can pressurize or evacuate an internal volume of the pressure chamber. The internal volume may then be connected to an internal volume of the device under test to test the device for leaks.

### CROSS REFERENCE TO RELATED APPLICATION

This application is a U.S. national phase of International Application No. PCT/EP2020/086763 filed Dec. 17, 2020, which is incorporated by reference herein in its entirety.

### FIELD OF DISCLOSURE

The present invention relates to a leak testing apparatus and to a method of testing a device for leaks.

### BACKGROUND

It is known in the prior art to test a device for one or more leaks using a leak testing apparatus to carry out a leak testing procedure. For example, U.S. Pat. Nos. 3,800,586 A, 4,587,619 A and 5,239,859 A describe different leak testing apparatuses and methods of testing a device for leaks using the different apparatuses respectively described therein.

U.S. Pat. No. 3,800,586 A describes connecting a device under test to a leak testing apparatus and subjecting the device under test to a test pressure by closing a valve to contain the test pressure in the device and measuring a change in pressure. The test apparatus measures the initial pressure in the device under test after the device is closed and compares the change in pressure to the initial pressure, thereby determining the extent of any leak in the device under test.

U.S. Pat. No. 4,587,619 A describes a method and apparatus for electronic leak testing using an electronic dynamic balance leak testing system. This system utilizes a “live zero” to detect any leaks in a device under test, wherein a source of test medium at a predetermined desired pressure or vacuum is connected to a device to be tested. After the device has been filled with the test medium, and an interval has been provided for the system to stabilize any effects due to wavefront oscillations, the device under test is momentarily isolated from the source of the test medium and a microcomputer system is used, both to cause the isolation, and to measure the differential pressure existing at two points in time during the test.

U.S. Pat. No. 5,239,859 A describes a method and apparatus for leak testing a hollow body, wherein the hollow body is placed in a test chamber. The hollow body is exposed to one of a positive or negative differential pressure between an internal pressure of the hollow body and a pressure in the test chamber. A pressure prevailing in the test chamber is tapped off from the test chamber at two points in time, with a signal being generated of a pressure differential between the values of the prevailing pressure in the test chamber at the two points of time. The tightness or change in volume of the hollow body is determined in dependence upon the generated pressure differential signal.

Prior art leak testing methods comprise both pressure decay tests and vacuum decay tests, according to each of which a device under test is respectively subjected to either a positive pressure or a negative pressure.

### SUMMARY

It is therefore an object of the invention to provide an improved leak testing apparatus and an improved method of testing a device for leaks.

The object of the invention is solved by a leak testing apparatus according to claim 1. The leak testing apparatus comprises a pump, a pressure chamber, a first valve, a second valve, a pressure sensing unit, a control, processing and decision unit, and a user interface with the control, processing and decision unit. The pump comprises at least first and second ports, wherein the first port is in fluid communication with a gas source or sink, and the pump is configured to pump a gas between the first and second ports thereof. The pressure chamber comprises an internal volume and at least first and second ports in fluid communication with the internal volume thereof. The first valve has at least an on state, which places the second port of the pump in fluid communication with the first port of the pressure chamber, and an off state preventing fluid communication between the second port of the pump and the first port of the pressure chamber. The second valve has at least an on state, which places the second port of the pressure chamber in fluid communication with an internal volume of a device under test, and an off state preventing fluid communication between the second port of the pressure chamber and the internal volume of the device under test. The pressure sensing unit at least comprises a pressure measurement output and is configured to repeatedly measure a pressure of the internal volume of the pressure chamber between a first time and a second time, as follows. The first time is when the pressure of the internal volume of the pressure chamber has a predetermined value, which is different from a pressure of the internal volume of the device under test, and the off state of the second valve prevents fluid communication between the internal volume of the pressure chamber and the internal volume of the device under test. The second time is when the pressure of the internal volume of the pressure chamber equilibrates with the pressure of the internal volume of the device under test after the on state of the second valve places the internal volume of the pressure chamber in fluid communication with the internal volume of the device under test. The control, processing and decision unit is configured to control the pump and the on and off states of the first and second valves, to receive a plurality of pressure measurements from the pressure measurement output of the pressure sensing unit, and to decide whether or not the device under test passes a leak test, based on a set of test data derived from the plurality of pressure measurements.

Since the pressure sensing unit repeatedly measures the pressure of the internal volume of the pressure chamber as it equilibrates with the pressure of the internal volume of the device under test, the set of test data derived from the plurality of pressure measurements is characteristic of the device under test. It may therefore may be considered as a “fingerprint” of the device under test. As the set of test data will be affected by the presence of one or more leaks in the device under test, the control, processing and decision unit is therefore able to decide whether or not the device under test passes a leak test by analysing this set of test data. In comparison to leak testing apparatuses of the prior art, which either compare a pressure value at the start of a leak test with a pressure value at the end of a leak test, or which merely time how long a device under test takes to reach a predetermined pressure, in order to decide whether the device under test passes the leak test, this has the advantage that the set of test data can be used to identify the location and nature of any possible leaks in the device under test by analysis of the set of test data. This analysis can be carried out by a user of the leak testing apparatus of the invention, or by the control, processing and decision unit thereof, when suitably programmed, or by a combination of the two.

This solution is also beneficial because unlike some leak testing apparatuses of the prior art, it does not require the gas source or sink to be regulated, which requires the use of more precisely manufactured and therefore costlier parts. Moreover, leak testing apparatuses of the prior art which use a regulated source of vacuum or pressurised gas may not be suitable for testing a wide range of different devices with different internal volumes from each other to similar levels of accuracy. This is because devices having different internal volumes which are subjected to a leak test using a regulated gas source or sink require different gas flow rates from each other to achieve the same level of accuracy. Instead, the apparatus of the invention can be easily adapted to test devices with different internal volumes from each other, either by changing the internal volume of the pressure chamber or by changing the predetermined value of the pressure in the internal volume of the pressure chamber to suit the internal volume of the device under test. The internal volume of the pressure chamber may easily be changed either by connecting together a plurality of pressure chambers, each having the same or similar internal volumes to each other, or by interchanging the pressure chamber with one of a different size, which is more suited to the internal volume of the device under test.

Advantageous embodiments of the invention may be configured according to any claim and/or part of the following description.

In some embodiments, the pressure sensing unit can measure the pressure of the internal volume of the pressure chamber at a temporal frequency of at least 10 Hz, preferably at least 100 Hz, more preferably at least 1 Khz, and most preferably at least 10 kHz. A pressure sensing unit which can repeatedly measure the pressure in the internal volume of the pressure chamber at a higher frequency has the advantage of increasing the temporal resolution of the set of test data which is generated. This is beneficial in revealing one or more features of the device under test, which might otherwise be indetectable by measuring the pressure in the internal volume of the pressure chamber at a lower frequency.

In some embodiments, the pressure sensing unit can measure the pressure of the internal volume of the pressure chamber with an accuracy less than or equal to 0.1%, preferably less than or equal to 1 part in 10 000, more preferably less than or equal to 1 part in 10⁵, and most preferably less than or equal to 1 part in 10⁶. A pressure sensing unit which can repeatedly measure the pressure in the internal volume of the pressure chamber with greater accuracy has the advantage of increasing the resolution in pressure of the set of test data which is generated. This is beneficial in revealing one or more features of the device under test which might otherwise be indetectable by measuring the pressure in the internal volume of the pressure chamber with lesser accuracy.

In some embodiments of the apparatus, the control, processing and decision unit is configured to decide whether or not the device under test passes a leak test by comparing the set of test data for the device under test with a set of control data, and if the set of test data is similar enough to the set of control data according to a predetermined criterion, to accept the device under test, whereas if the set of test data is not similar enough to the set of control data according to the predetermined criterion, to reject the device under test.

The set of control data may, for example, be derived from a plurality of sets of test data, each generated by other devices of the same type as the device under test when connected to the same leak testing apparatus and subjected to the same leak testing procedure. On the other hand, the set of control data may instead be a set of test data generated by a single device of the same type as the device under test when connected to the same leak testing apparatus and subjected to the same leak testing method. This single device may either be a standardised archetype of the type of device under test or it may be an example of the same type as the device under test which has particular features, such as one or more leaks in known locations.

The predetermined criterion may, for example, be a predetermined degree of similarity or difference between the set of test data and the set of control data. The predetermined criterion may be a fixed criterion a dynamic criterion, which in the latter case, changes as successive devices are connected to the same leak testing apparatus and subjected to the same leak testing method.

If so, the control, processing and decision unit may be configured to derive the predetermined criterion by machine learning from a plurality of devices of the same type as the device under test, wherein each of the plurality of devices of the same type has been subjected to the same leak testing procedure as the device under test. This solution is beneficial because it improves the accuracy with which the control, processing and decision unit is able to determine whether a device under test should be accepted or rejected, as the number of devices of the same type which are connected to the same leak testing apparatus and subjected to the same leak testing method increases.

In some embodiments, the control, processing and decision unit may be configured to receive status information from at least one of the pump and the first and second valves, such as their respective on and off states, the rate of operation of the pump when in its on state, and so on. This solution is beneficial because it allows the control, processing and decision unit to exercise closed loop control, rather than just open loop control, of at least one of the pump and the first and second valves.

The present invention also relates to a method of testing a device for leaks. The method at least comprises: pumping a gas into or out of a sealed pressure chamber until a pressure of an internal volume of the pressure chamber reaches a predetermined value, then closing the pressure chamber in a gas-tight manner; closing any orifices of the device under test which would otherwise place an internal volume of the device under test in fluid communication with an environment of the device under test; connecting the internal volume of the device under test in fluid communication with the internal volume of the pressure chamber; repeatedly measuring the pressure in the internal volume of the pressure chamber until the pressure in the internal volume of the pressure chamber equilibrates with a pressure in the internal volume of the device under test, to generate a set of test data; and comparing the set of test data thus generated with a set of control data. If the set of test data is similar enough to the set of control data according to a predetermined criterion, the device under test is accepted, whereas if the set of test data is not similar enough to the set of control data according to the predetermined criterion, the device under test is rejected.

The set of control data may, for example, be an arithmetic or geometric average of a plurality of sets of test data, each generated by other devices of the same type as the device under test, when subjected to the same leak testing method. On the other hand, the set of control data may be a set of test data generated by a single device of the same type as the device under test, when subjected to the same leak testing method. The aforementioned single device may either be a standardised archetype of the type of device under test or it may be an example of the same type as the device under test which has particular features, such as one or more leaks in known locations.

The predetermined criterion may, for example, be a predetermined degree of similarity or difference between the set of test data and the set of control data. The predetermined criterion may also be a fixed criterion or it may be a dynamic criterion, which changes as successive devices are subjected to the same leak testing method.

This solution is beneficial because repeatedly measuring the pressure in the internal volume of the pressure chamber until the pressure in the internal volume of the pressure chamber equilibrates with a pressure in the internal volume of the device under test provides a set of test data which is characteristic of the device under test, and which may therefore be considered as a “fingerprint” of the device under test. Rather than just determining whether the device under test should be accepted or rejected, this can therefore also help in identifying the type and/or location of any leaks in a device which is rejected, by comparing the set of test data for the device under test with other sets of test data generated by other devices of the same type as the device under test.

In some embodiments, repeatedly measuring the pressure in the internal volume of the pressure chamber comprises repeatedly measuring the pressure in the internal volume of the pressure chamber at a temporal frequency of at least 10 Hz, preferably at least 100 Hz, more preferably at least 1 Khz, and most preferably at least 10 kHz. Repeatedly measuring the pressure in the internal volume of the pressure chamber at a higher frequency has the advantage of increasing the temporal resolution of the set of test data, which is characteristic of the device under test. This may therefore reveal one or more features of the device under test, which would otherwise be indetectable by measuring the pressure in the internal volume of the pressure chamber at a lower frequency.

In some embodiments, repeatedly measuring the pressure in the internal volume of the pressure chamber comprises repeatedly measuring the pressure in the internal volume of the pressure chamber with an accuracy less than or equal to 0.1%, preferably less than or equal to 1 part in 10 000, more preferably less than or equal to 1 part in 10⁵, and most preferably less than or equal to 1 part in 10⁶. Repeatedly measuring the pressure in the internal volume of the pressure chamber with greater accuracy has the advantage of increasing the resolution in pressure of the set of test data, which is characteristic of the device under test. This may therefore also reveal one or more features of the device under test which would otherwise be indetectable by measuring the pressure in the internal volume of the pressure chamber with lesser accuracy.

In some embodiments, comparing the set of test data with a set of control data comprises comparing the shape of a graph representing the set of test data with the shape of a graph representing the set of control data, wherein each said graph plots the pressure in the internal volume of the pressure chamber against time. This solution is beneficial because the shape of the graph representing the set of test data allows the characteristics of the device under test to be easily identified. Similarly, the shape of the graph representing the set of control data allows the characteristics of an ideal example of the same type of device as the device under test to be easily identified as well.

For example, the shape of each graph may be defined by a respective line of best fit to each of the set of test data and the set of control data obtained by polynomial regression, and comparing the shape of each graph may comprise comparing the coefficients of the terms in each respective polynomial. Defining each such graph by a polynomial expression and comparing the shape of each such graph by comparing the coefficients of the terms in each respective polynomial provides an easy way in which the degree of similarity between the two graphs can be quantified.

If the shape of a graph representing the set of test data is compared with the shape of a graph representing the set of control data, comparing the shape of each such graph may comprise comparing the respective locations in each graph (i.e. co-ordinates) of at least one, and preferably several, local maxima, minima and/or points of inflection. This solution is beneficial because the respective locations of the local maxima, minima and/or points of inflection in the two graphs may be diagnostic of particular features of the device under test, as well as of an ideal example of the same type of device as the device under test.

In some embodiments, the method may comprise deriving the predetermined criterion by machine learning from a plurality of devices of the same type as the device under test, wherein each of the plurality of devices of the same type has been subjected to the same leak testing method as the device under test. This solution is beneficial because it improves the accuracy with which the leak testing method is able to determine whether a device under test should be accepted or rejected, as the number of devices of the same type which are subjected to the same leak testing method increases.

In some embodiments, the method may further comprise selecting the internal volume of the pressure chamber to be approximately equal to the internal volume of the device under test. For example, the internal volume of the pressure chamber may be selected to be not more than 4 times as large, preferably not more than 3 times as large, more preferably not more than 2 times as large as and not less than ¼, preferably not less than ⅓, more preferably not less than ½ of the internal volume of the device under test. This solution is beneficial because approximately matching the internal volume of the pressure chamber to the internal volume of the device under test in this way can be used to increase the sensitivity of the leak test.

In some embodiments, pumping a gas into or out of a sealed pressure chamber until a pressure of an internal volume of the pressure chamber reaches a predetermined value may comprise pumping gas out of the sealed pressure chamber until the pressure chamber is completely evacuated. In such a case, the device under test is subjected to a leak test using a vacuum when the second valve is opened. This has the advantage of being more suitable for testing devices with larger internal volumes than a leak test using a pressurised gas.

In some embodiments, the method of testing a device for leaks may comprise using a leak testing apparatus as described herein.

Further features, goals and advantages of the present invention will now be described in association with the accompanying drawings, in which exemplary components of the invention are illustrated. Components of the devices and methods according to the invention which are at least essentially equivalent to each other with respect to their function can be marked by the same reference numerals, wherein such components do not have to be marked or described in all of the drawings.

In the following description, the invention is described by way of example only with respect to the accompanying drawings.

### BRIEF DESCRIPTION OF THE DRAWINGS

FIG. 1 is a block diagram schematically representing an embodiment of a leak testing apparatus;

FIG. 2 is a flow diagram schematically representing an embodiment of a method of testing a device for leaks, which may be conducted using a leak testing apparatus such as that shown in FIG. 1;

FIG. 3A is a graph schematically showing a first representative example of a set of test data and control data measured with the leak testing apparatus of FIG. 1; and

FIG. 3B is a graph schematically showing a second representative example of a set of test data and control data measured with the leak testing apparatus of FIG. 1.

### DETAILED DESCRIPTION

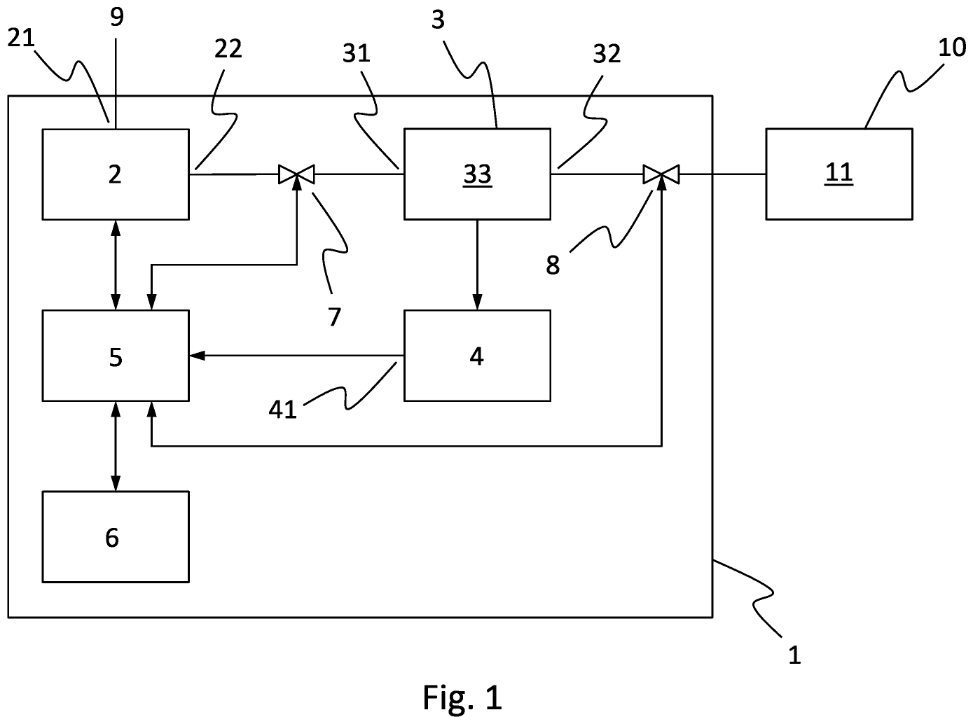

FIG. 1 schematically shows an embodiment of a leak testing apparatus 1, which can be used to find one or more leaks in a device 10 under test. The leak testing apparatus 1 comprises a pump 2, a pressure chamber 3, a pressure sensing unit 4, a control, processing and decision unit 5, a user interface 6, a first valve 7 and a second valve 8. Since the leak testing apparatus 1 is intended to detect leaks, it is of course important that the leak testing apparatus 1 is itself manufactured and maintained to a high enough standard to ensure that it is substantially free of leaks, which would otherwise interfere with its correct operation. The foregoing and following description therefore assume throughout that the leak testing apparatus 1 is itself substantially leak-free.

The pump 2 of the leak testing apparatus 1 comprises first and second ports 21, 22. The first port 21 is in fluid communication with a gas source or sink 9, such as air from the environment of the leak testing apparatus 1 or from a bottle of test gas, and the pump 2 is configured to pump a gas between the first port 21 and the second port 22. Thus, either the pump 2 may pump gas from a gas source 9 via the first port 21 to the second port 22, in which case the pump 2 may be used to pressurise something placed in fluid communication with the second port 22, or the pump 2 may pump gas from the second port 22 via the first port 21 to a sink 9 (such as to the atmosphere), in which case the pump 2 may be used to evacuate something placed in fluid communication with the second port 22.

The pressure chamber 3 comprises an internal volume 33 and first and second ports 31, 32, both of which are in fluid communication with the internal volume 33 of the pressure chamber 3. The pressure chamber 3 is sufficiently rigid that the internal volume 33 thereof remains constant if the pressure chamber 3 is partially or completely evacuated or pressurised during operation of the leak testing apparatus 1. The internal volume 33 of the pressure chamber 3 can be chosen to be approximately equal to the internal volume 11 of the device 10 under test in one of two ways, as follows. Firstly, one of a plurality of different pressure chambers 3 with differently sized internal volumes 11 can be chosen to be approximately equal to the internal volume 11 of the device 10 under test. Secondly, a plurality of pressure chambers 3 with internal volumes 11 of the same or similar size to each other can be connected together to create a combined internal volume which is approximately equal to the internal volume 11 of the device 10 under test.

The first valve 7 has an on state, which places the second port 22 of the pump 2 in fluid communication with the first port 31 of the pressure chamber 3, and an off state, which prevents fluid communication between the second port 22 of the pump 2 and the first port 31 of the pressure chamber 3. The second valve 8 has on state, which places the second port 32 of the pressure chamber 3 in fluid communication with the internal volume 11 of the device 10 under test, and an off state which prevents fluid communication between the second port 32 of the pressure chamber 3 and the internal volume 11 of the device 10 under test.

The pressure sensing unit 4 comprises a pressure measurement output 41 and is configured to repeatedly measure a pressure of the internal volume 33 of the pressure chamber 3 at least between two different moments in time, as follows. The first time is when the pressure of the internal volume 33 of the pressure chamber 3 has a predetermined value, p₁, which is different from a pressure of the internal volume 11 of the device 10 under test, and the off state of the second valve 8 prevents fluid communication between the internal volume 33 of the pressure chamber 3 and the internal volume 11 of the device 10 under test. The second time is when the pressure of the internal volume 33 of the pressure chamber 3 equilibrates with the pressure of the internal volume 11 of the device 10 under test after the on state of the second valve 8 places the internal volume 33 of the pressure chamber 3 in fluid communication with the internal volume 11 of the device 10 under test. The pressure sensing unit 4 can measure the pressure of the internal volume 33 of the pressure chamber 3 at a high temporal frequency (i.e. a high sampling rate) and with high resolution (i.e. a high accuracy in pressure).

The control, processing and decision unit 5 is configured to control the pump 2 and the on and off states of the first and second valves 7, 8. It is also configured to receive a plurality of pressure measurements from the pressure measurement output 41 of the pressure sensing unit 4. The control, processing and decision unit 5 is configured to decide whether or not the device 10 under test passes a leak test, based on a set of test data 51a, 51b derived from the plurality of pressure measurements. Finally, the control, processing and decision unit 5 is also configured to receive status information from the pump 2 and from the first and second valves 7, 8, such as whether the pump 2 is switched on or off and whether the first and second valves 7, 8 are in their respective on or off states. The control, processing and decision unit 5 may comprise a memory to store the test data 51a, 51b, control data and/or one or more programs for its operation.

The user interface 6, which is connected in two-way communication with the control, processing and decision unit 5, is configured to enable a user of the leak testing apparatus 1 to interact with the control, processing and decision unit 5. For example, the user interface 6 allows a user to command the control, processing and decision unit 5 to start or stop a leak test and to receive the result of a leak test from the control, processing and decision unit 5.

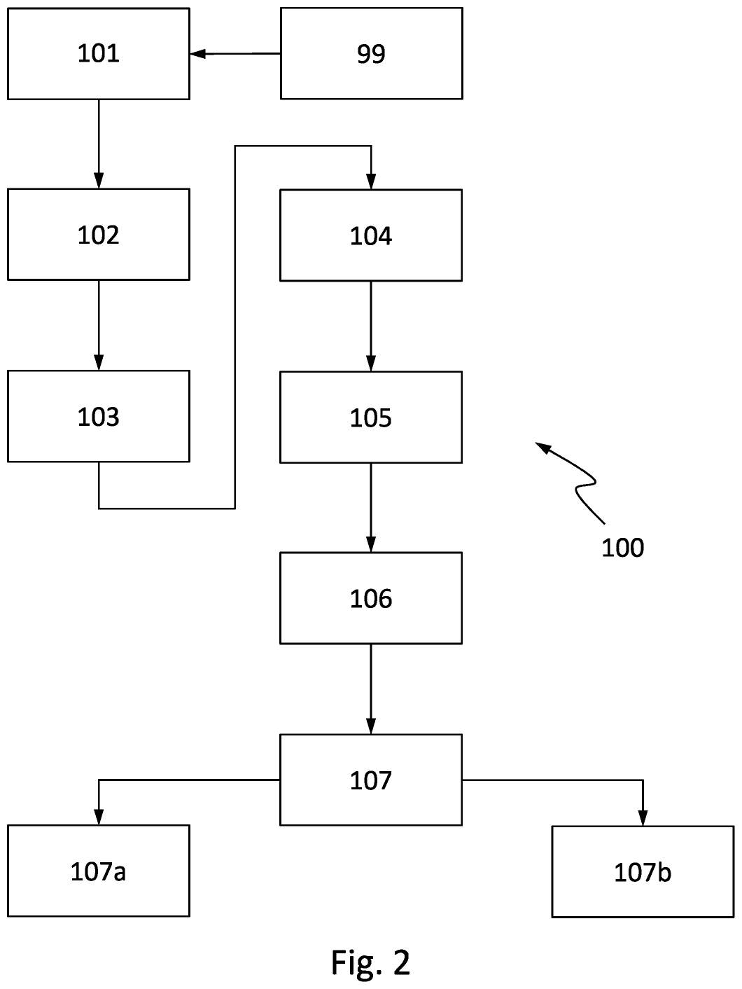

How the leak testing apparatus 1 operates will be better understood by reference to the following detailed description given in relation to FIG. 2.

FIG. 2 schematically shows an embodiment of a method 100 of testing a device for leaks, which may be carried out using the leak testing apparatus 1 of FIG. 1. In order to adapt the leak testing apparatus 1 for detecting leaks in devices 10 having different internal volumes 11, the method 100 may initially comprise selecting 99 the internal volume 33 of the pressure chamber 3 to be approximately equal to the internal volume 11 of the device 10 under test. This has the effect of improving the sensitivity of the leak testing apparatus 1 to detecting leaks in the device 10 under test by avoiding a large mismatch between the respective internal volumes of the pressure chamber 3 and the device 10 under test. For example, the internal volume 33 of the pressure chamber 3 may be selected 99 to be not more than 3 times as large as and not less than ⅓ of the internal volume 11 of the device 10 under test. However, this initial selection 99 is optional, since the sensitivity of the leak testing apparatus 1 for detecting leaks in the device 10 under test may also be adjusted by alternatively or additionally changing a predetermined value, p₁, of the pressure in the internal volume 33 of the pressure chamber 3 to suit different internal volumes 11 for the device 10 under test. For example, the predetermined value, p₁, may be entered into the control, processing and decision unit 5 via the user interface 6.

The method 100 comprises pumping 101 a gas into or out of the sealed pressure chamber until the pressure of the internal volume, V₁, of the pressure chamber reaches the predetermined value, p₁. For example, in the leak testing apparatus 1 of FIG. 1, the pressure chamber 3 may be sealed by putting the second valve 8 in its off state, thereby preventing fluid communication between the second port 32 of the pressure chamber 3 and the internal volume 11 of the device 10 under test. Gas may then be pumped 101 into or out of the pressure chamber 3 by putting the first valve 7 in its on state, thereby placing the first port 31 of the pressure chamber 3 in fluid communication with the second port 22 of the pump 2, and switching the pump 2 on. The pump 2 then either pressurises or evacuates the pressure chamber 3 by pumping gas between the gas source or sink 9 and the pressure chamber 3, until the predetermined value, p₁, is reached. In the special case where the pump 2 evacuates the pressure chamber 3 completely to a gas sink 9, in order to create a vacuum in the pressure chamber 3, the predetermined value, p₁=0.

When the predetermined value, p₁, has been reached, the method comprises closing 102 the pressure chamber in a gas-tight manner. For example, in the leak testing apparatus 1 of FIG. 1, the pressure chamber 3 may be closed 102 in a gas-tight manner by putting the first valve 7 in its off state, thereby preventing fluid communication between the first port 31 of the pressure chamber 3 and the second port 22 of the pump 2. The pump 2 may then be switched off. In the leak testing apparatus 1 of FIG. 1, the first and second valves 7, 8 may be put in their respective on and off states and the pump 2 may be switched on and off by the control, processing and decision unit 5 according to a predetermined procedure. For example, the control, processing and decision unit 5 may use closed-loop control, in reliance on pressure measurements received from the pressure measurement output 41 of the pressure sensing unit 4, in order to determine when the predetermined value, p₁, has been reached. This predetermined procedure may be stored in a memory of the control, processing and decision unit 5 as a program. The predetermined value, p₁, of the pressure inside the pressure chamber 3 may also be stored in the memory thereof either in advance of the leak test or after it has been entered into the control, processing and decision unit 5 by a user via the user interface 6.

The method 100 also comprises closing 103 any orifices of the device under test which would otherwise place an internal volume of the device under test in fluid communication with an environment of the device under test, and then connecting 104 the internal volume of the device under test in fluid communication with the internal volume of the pressure chamber. For example, in the leak testing apparatus 1 of FIG. 1, the internal volume 11 of the device 10 under test may be connected 104 in fluid communication with the internal volume 33 of the pressure chamber 3 by the control, processing and decision unit 5 putting the second valve 8 in its on state, thereby placing the second port 32 of the pressure chamber 3 in fluid communication with the internal volume 11 of the device 10 under test.

The value of the internal volume 11 of the device 10 under test may be denoted by V₀, containing gas at a pressure Po, before the internal volume 11 of the device 10 under test is connected 104 in fluid communication with the internal volume 33 of the pressure chamber 3. The sum of the internal volume, V₀, of the device 10 under test and the internal volume, V₁, of the pressure chamber 3 may then be denoted by a combined volume, V₂=V₀+V₁, and the pressure of the gas in the combined volume, V₂, will eventually adopt a new value, p₂, as the pressure of the internal volume of the pressure chamber 3 equilibrates with a pressure of the internal volume of the device 10 under test. In the special case where the pump 2 has evacuated the pressure chamber 3 completely, so that p₁=0 before the internal volume of the device 10 under test is connected 104 in fluid communication with the internal volume of the pressure chamber 3, the quantity of gas in the combined volume, V₂, remains constant after the internal volume of the device 10 under test has been connected 104 in fluid communication with the internal volume of the pressure chamber 3. Then, in such a case, by Boyle's law, p₂V₂=p₀V₀, provided that the internal volume, V₀, of the device under test remains the same before and after the leak test (for example, the device 10 under test may be distorted by being pressurized or partially or completely evacuated) and that the temperature, T, of both the leak testing apparatus 1 and the device 10 under test do not change during the test (for example, by adiabatic heating or cooling of the test gas).

During the leak test, the method 100 comprises repeatedly measuring 105 the pressure in the internal volume of the pressure chamber until the pressure in the internal volume of the pressure chamber equilibrates with the pressure in the internal volume of the device under test, in order to generate a set of test data. For example, in the leak testing apparatus 1 of FIG. 1, the pressure in the internal volume 33 of the pressure chamber 3 may be measured 105 by the pressure sensing unit 4, and the control, processing and decision unit 5 may generate the set of test data from a plurality of pressure measurements received from the pressure measurement output 41 of the pressure sensing unit 4.

The method 100 then comprises comparing 106 the set of test data thus generated with a set of control data. For example, in the leak testing apparatus 1 of FIG. 1, the control, processing and decision unit 5 may compare the set of test data thus generated with a set of control data stored in a memory of the unit 5.

If the set of test data is similar enough to the set of control data according to a predetermined criterion, the method 100 comprises accepting 107a the device under test, whereas if the set of test data is not similar enough to the set of control data according to the predetermined criterion, the method 100 comprises rejecting 107b the device under test. For example, in the leak testing apparatus 1 of FIG. 1, the control, processing and decision unit 5 may decide whether to accept 107a or reject 107b the device 10 under test according to the predetermined criterion and may also indicate via the user interface 6 whether the device 10 under test has been accepted or rejected. For example, the user interface 6 may comprise a display screen, giving a visible indication of whether the device 10 has been accepted or rejected, and/or a loudspeaker, giving an audible signal of whether the device has been accepted or rejected.

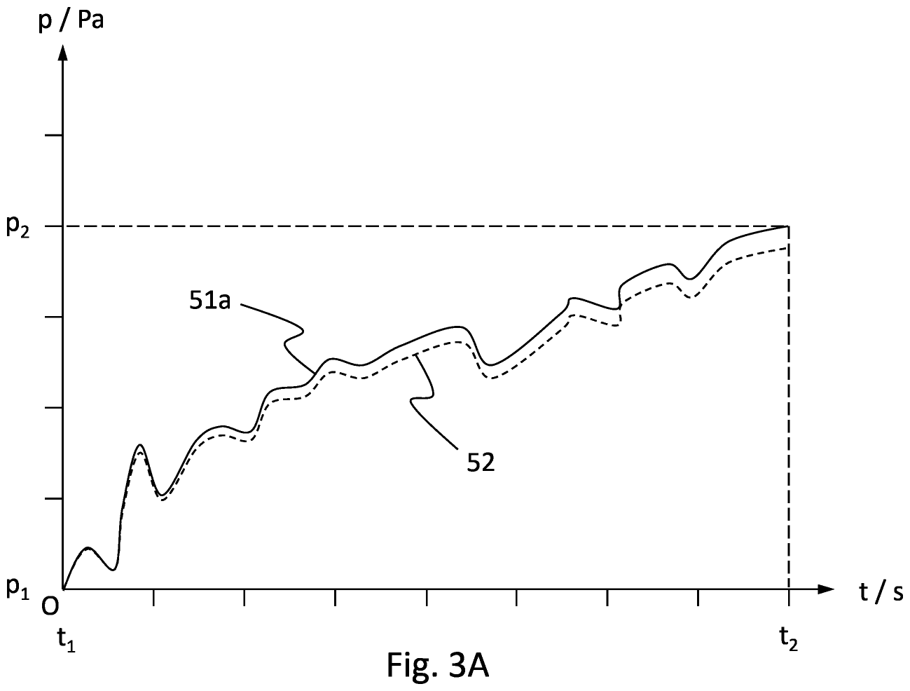

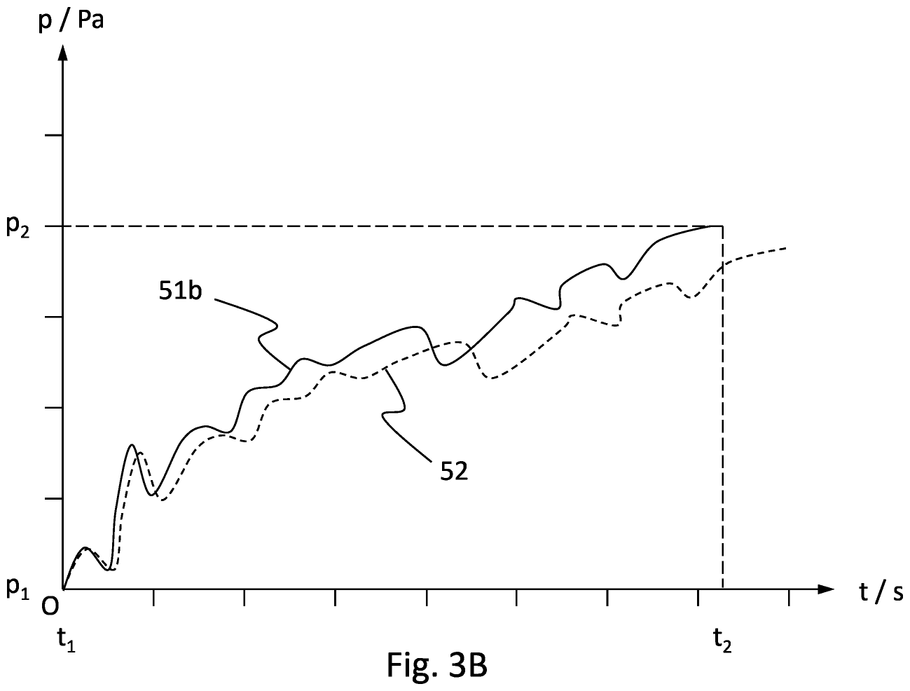

How the control, processing and decision unit 5 decides to accept 107a or reject 107b the device 10 under test will be better understood by reference to the following detailed description given in relation to FIGS. 3A and 3B. FIGS. 3A and 3B are both graphs, which plot pressure, p, measured in Pascals, Pa, on the y-axis or ordinate against time, t, measured in seconds, s, on the x-axis or abscissa.

FIG. 3A shows an example of a first set of test data 51a, represented by a continuous line, and a set of control data 52, represented by a dashed line, both of which are measured by the leak testing apparatus of FIG. 1. In the leak test depicted in FIG. 3A, the pump 2 has completely evacuated the pressure chamber 3 at the start of the leak test, so that the predetermined value of the pressure inside the pressure chamber 3, p₁=0.

The first set of test data 51a is derived from a plurality of pressure measurements from the pressure measurement output 41 of the pressure sensing unit 4. These pressure measurements are made during the time between when the internal volume 33 of the pressure chamber 3 is connected in fluid communication with the internal volume 11 of the device 10 under test (indicated in FIG. 3A by t₁) and when the pressure in the internal volume 33 has equilibrated with the pressure in the internal volume 11 (indicated in FIG. 3A by t 2). The pressure sensing unit 4 makes these pressure measurements at a high temporal frequency and with a high resolution in pressure, in order that the control, processing and decision unit 5 can capture the shape of the line 51a, including any local maxima, minima and points of inflection it may contain. For example, the pressure sensing unit 4 measures the pressure of the internal volume 33 of the pressure chamber 3 at a temporal frequency of at least 10 Hz and with a resolution in pressure of less than 0.1%.

The shape of the line 51a, including any local maxima, minima and points of inflection it may contain, is determined by the shape, configuration and material construction of the internal volume 11 of the device 10 under test. These features of the device 10 under test cause acoustic vibrations in the gas as it diffuses into the combined internal volume 11, 33, as the pressure of the gas in the internal volume 33 equilibrates with the pressure of the gas in the internal volume 11, in a similar manner to how the timbre of a musical instrument of the woodwind or brass family is affected by the internal shape, configuration and material construction of the musical instrument. The shape of the line 51a can therefore be considered as a “fingerprint”, which is characteristic of the device 10 under test.

The set of control data 52 is derived from one or more devices of the same type as the device 10 under test, each of which has been subjected to the same leak testing procedure as the device 10 under test. For example, the set of control data 52 may be derived from a single, standardized example (i.e. an archetype) of the same type of device as the device 10 under test, or it may be derived from a plurality of devices of the same type as the device 10 under test, wherein a set of test data obtained from each one of the plurality of devices of the same type using the same leak testing procedure has been subjected to a statistical analysis (e.g. arithmetic or geometric averaging), in order to obtain the set of control data 52. Since the plurality of devices from which the set of control data 52 is derived are of the same type as the device 10 under test, the shape of the line 52 is broadly similar to the shape of the line 51a and exhibits corresponding local maxima, minima and points of inflection. However, due to manufacturing variations, the first set of test data 51a differs slightly from the set of control data 52, as shown in FIG. 3A. FIG. 3A shows an exemplary case in which the first set of test data 51a is sufficiently similar to the set of control data 52, according to a predetermined criterion, for the control, processing and decision unit 5 to accept 107a the device 10 under test.

In contrast, FIG. 3B shows an exemplary case in which a second set of test data 51b is not sufficiently similar to the same set of control data 52, according to the same predetermined criterion, for the control, processing and decision unit 5 to accept 107a a different example of the same type of device under test. This causes the control, processing and decision unit 5 to reject 107b the different example of the device under test instead.

In FIG. 3B, the same set of control data 52 as is represented in FIG. 3A is also represented by a dashed line. However, in FIG. 3B, the continuous line instead represents the second set of test data 51b, which is measured by the leak testing apparatus of FIG. 1 according to the same leak testing procedure. In this case, since the device under test has one or more leaks, although the shape of the line 51b is broadly similar to the shape of the line 52, the pressure in the internal volume 33 of the pressure chamber 3 takes less time to reach p₂ than in FIG. 3A, so that the time period t₂−t₁ in FIG. 3B is less than the time period t₂−t₁ in FIG. 3A, as may be seen by comparing FIG. 3B with FIG. 3A. The locations of the local maxima, minima and points of inflection in the line 51b are therefore different from the locations of the respective local maxima, minima and points of inflection in the line 51a. The line 51b therefore fails to follow the line 52 closely, unlike in FIG. 3A.

The predetermined criterion according to which the control, processing and decision unit 5 accepts or rejects the device 10 under test may be established in one of several, different ways. For example, the predetermined criterion may be established by a statistical analysis of each set of test data 51a, 51b, such as by using polynomial regression to find a line of best fit for each set of test data 51a, 51b, as well as to assemble the set of control data 52, and then seeing whether each set of test data 51a, 51b falls within a predetermined number of standard deviations of the set of control data 52. Preferably, however, the control, processing and decision unit 5 derives the predetermined criterion by machine learning from a plurality of devices of the same type as the device 10 under test, wherein each of the plurality of devices of the same type is subjected to the same leak testing procedure as the device under test. In this way, the control, processing and decision unit 5 can identify sets of test data which are outliers from the set of control data with increasing accuracy, as the number of devices of the same type, which are subjected to the same leak testing procedure, increases.

Whereas FIGS. 3A and 3B both show leak tests in which the pressure chamber 3 has been evacuated by the pump 2 at the start of the leak test, so that p₂>p₁, in other leak tests using the same leak testing apparatus 1 of FIG. 1 and conducted according to the same method as shown in FIG. 2, the pressure chamber 3 could instead be pressurised by the pump 2 at the start of the leak test, so that in such cases, p₂<p₁.

In summary, therefore, the present invention provides a leak testing apparatus and a method of testing a device for leaks. The device under test may be an industrial product. For example, the device under test may be an electrical housing, comprising one or more orifices for entry of electrical cables, which orifices can be sealed by electrical glands to provide the housing with ingress protection. The leak testing apparatus comprises a pump, a pressure chamber, a pressure sensing unit, a control, processing and decision unit and a user interface. A first valve under control of the control, processing and decision unit can connect the pump to the pressure chamber, and a second valve under control of the control, processing and decision unit can connect the pressure chamber to the device under test. The pump is connected to a gas source or sink, such as to the atmosphere or a bottle of test gas. The pump can therefore pressurize or evacuate an internal volume of the pressure chamber under control of the control, processing and decision unit. This internal volume may then be connected to an internal volume of the device under test, for example via one of its sealable orifices, the other orifices of the device having been sealed from the environment, in order to test the device for leaks. The pressure sensing unit has a high resolution and is able to sample the pressure in the internal volume of the pressure chamber at a high frequency, in order to derive a set of test data for the device under test. The set of test data, which is determined by the internal shape, configuration and material construction of the device under test, is characteristic of the device under test. Since the set of test data will be affected by the presence of one or more leaks in the device under test, the control, processing and decision unit can analyse the set of test data, for example by comparing it with a set of control data, to decide whether or not the device under test passes the leak test, and can output the result of the leak test to the user interface.

Reference Numerals:

| | |
|---|---|
| 1 | Leak testing apparatus |
| 2 | Pump |
| 3 | Pressure chamber |
| 4 | Pressure sensing unit |
| 5 | Control, processing and decision |
| | unit |
| 6 | User interface |
| 7 | First valve |
| 8 | Second valve |
| 9 | Gas source or sink |
| 10 | Device under test |
| 11 | Internal volume of device under |
| | test |
| 21 | First port of pump |
| 22 | Second port of pump |
| 31 | First port of pressure chamber |
| 32 | Second port of pressure chamber |
| 33 | Internal volume of pressure |
| | chamber |
| 41 | Pressure measurement output of |
| | pressure sensing unit |
| 51a | First set of test data |
| 51b | Second set of test data |
| 52 | Control data |
| 100 | Leak testing method |
| 101 | Pump fluid into or out of sealed |
| | pressure chamber |
| 102 | Close pressure chamber in a |
| | fluid-tight manner |
| 103 | Close any orifices of the device |
| | under test |
| 104 | Connect internal volume of |
| | device under test with internal |
| | volume of pressure chamber |
| 105 | Repeatedly measure pressure of |
| | internal volume of pressure |
| | chamber |
| 106 | Compare test data with control |
| | data |
| 107a | Accept device under test |
| 107b | Reject device under test |

1. A leak testing apparatus at least comprising:
a pump comprising at least first and second ports, wherein the first port is in fluid communication with a gas source or sink, and the pump is configured to pump gas between the first and second ports thereof;
a pressure chamber comprising an internal volume and at least first and second ports in fluid communication with the internal volume thereof;
a first valve having at least an on state placing the second port of the pump in fluid communication with the first port of the pressure chamber and an off state preventing fluid communication between the second port of the pump and the first port of the pressure chamber;
a second valve having at least an on state placing the second port of the pressure chamber in fluid communication with an internal volume of a device under test and an off state preventing fluid communication between the second port of the pressure chamber and the internal volume of the device under test;
a pressure sensing unit at least comprising a pressure measurement output, wherein the pressure sensing unit is configured to repeatedly measure a pressure of the internal volume of the pressure chamber between:
a first time, when the pressure of the internal volume of the pressure chamber has a predetermined value, which is different from a pressure of the internal volume of the device under test, and the off state of the second valve prevents fluid communication between the internal volume of the pressure chamber and the internal volume of the device under test, and
a second time, when the pressure of the internal volume of the pressure chamber equilibrates with the pressure of the internal volume of the device under test after the on state of the second valve places the internal volume of the pressure chamber in fluid communication with the internal volume of the device under test;
a control, processing and decision unit configured to control the pump and the on and off states of the first and second valves, to receive a plurality of pressure measurements from the pressure measurement output of the pressure sensing unit, and to decide whether or not the device under test passes a leak test, based on a set of test data derived from the plurality of pressure measurements; and
a user interface with the control, processing and decision unit.

2. A leak testing apparatus according to claim 1, wherein the pressure sensing unit can measure the pressure of the internal volume of the pressure chamber at a temporal frequency of at least 10 Hz.

3. A leak testing apparatus according to claim 1, wherein the pressure sensing unit can measure the pressure of the internal volume of the pressure chamber with an accuracy less than or equal to 0.1%.

4. A leak testing apparatus according to claim 1, wherein the control, processing and decision unit is configured to decide whether or not the device under test passes a leak test by comparing the set of test data for the device under test with a set of control data, and if the set of test data is similar enough to the set of control data according to a predetermined criterion, to accept the device under test, whereas if the set of test data is not similar enough to the set of control data according to the predetermined criterion, to reject the device under test.

5. A leak testing apparatus according to according to claim 4, wherein the control, processing and decision unit is configured to derive the predetermined criterion by machine learning from a plurality of devices of the same type as the device under test, wherein each of the plurality of devices of the same type has been subjected to the same leak testing procedure as the device under test.

6. A leak testing apparatus according to claim 1, wherein the control, processing and decision unit is configured to receive status information from at least one of the pump and the first and second valves.

7. A method of testing a device for leaks, wherein the method at least comprises:
pumping a gas into or out of a sealed pressure chamber until a pressure of an internal volume of the pressure chamber reaches a predetermined value;
when the pressure in the internal volume of the pressure chamber has reached the predetermined value, closing the pressure chamber in a gas-tight manner;
closing any orifices of the device under test which would otherwise place an internal volume of the device under test in fluid communication with an environment of the device under test;
connecting the internal volume of the device under test in fluid communication with the internal volume of the pressure chamber;
repeatedly measuring the pressure in the internal volume of the pressure chamber until the pressure in the internal volume of the pressure chamber equilibrates with a pressure in the internal volume of the device under test to generate a set of test data;
comparing the set of test data thus generated with a set of control data; and
if the set of test data is similar enough to the set of control data according to a predetermined criterion, accepting the device under test;
whereas if the set of test data is not similar enough to the set of control data according to the predetermined criterion, rejecting the device under test.

8. A method according to claim 7, wherein repeatedly measuring the pressure in the internal volume of the pressure chamber comprises repeatedly measuring the pressure in the internal volume of the pressure chamber at a temporal frequency of at least 10 Hz.

9. A method according to claim 7, wherein repeatedly measuring the pressure in the internal volume of the pressure chamber comprises repeatedly measuring the pressure in the internal volume of the pressure chamber with an accuracy less than or equal to 0.1%.

10. A method according to claim 7, wherein comparing the set of test data with a set of control data comprises comparing the shape of a graph representing the set of test data with the shape of a graph representing the set of control data, wherein each said graph plots the pressure in the internal volume of the pressure chamber against time.

11. A method according to claim 10, wherein comparing the shape of a graph representing the set of test data with the shape of a graph representing the set of control data comprises comparing the respective locations in each graph of at least one local maximum, minimum or point of inflection.

12. A method according to claim 7, comprising deriving the predetermined criterion by machine learning from a plurality of devices of the same type as the device under test, wherein each of the plurality of devices of the same type has been subjected to the same leak testing method as the device under test.

13. A method according to claim 7, further comprising:
selecting the internal volume of the pressure chamber to be not more than 3 times as large as and not less than ⅓ of the internal volume of the device under test.

14. A method according to claim 7, wherein pumping a gas into or out of a sealed pressure chamber until a pressure of an internal volume of the pressure chamber reaches a predetermined value comprises pumping gas out of the sealed pressure chamber until the pressure chamber is completely evacuated.

15. A method comprising using an apparatus according to claim 1 to test the device for leaks.
